(19) United States
(12) Patent Application Publication
(10) Pub. No.: US 2018/0288638 A1
(43) Pub. Date: Oct. 4, 2018

(54) TERMINAL APPARATUS, BASE STATION APPARATUS, AND COMMUNICATION METHOD

(71) Applicant: SHARP KABUSHIKI KAISHA, Sakai City, Osaka (JP)

(72) Inventors: KATSUYA KATO, Sakai City (JP); RYOTA YAMADA, Sakai City (JP); YASUHIRO HAMAGUCHI, Sakai City (JP)

(73) Assignee: SHARP KABUSHIKI KAISHA, Sakai City, Osaka (JP)

(21) Appl. No.: 15/764,466

(22) PCT Filed: Aug. 26, 2016
(86) PCT No.: PCT/JP2016/074933

§ 371 Date: Mar. 29, 2018

(30) Foreign Application Priority Data
Oct. 5, 2015 (JP) 2015-197490

(51) Int. Cl. H04W 24/08; H04L 12/24; H04W 24/02

(52) U.S. Cl. CPC H04W 24/08; H04L 41/0631; H04W 24/02; H04L 41/0677

(57) ABSTRACT

A terminal apparatus reduces power consumption and recognizes malfunction information using a control terminal apparatus. A terminal apparatus of the present invention includes a reception unit that receives a radio parameter and malfunction information from a base station apparatus, a connection unit that makes connection to an end terminal apparatus including a data transmission function and transmits a parameter including the radio parameter to the end terminal apparatus, and a display unit that displays position information of an end terminal apparatus having a malfunction in a case where the malfunction information is received. Alternatively, a terminal apparatus of the present invention includes a connection unit that makes connection to a control terminal apparatus including a function of performing radio communication with a base station apparatus and receives a radio parameter from the control terminal apparatus, and a transmission unit that transmits a data signal to the base station apparatus using the radio parameter. The transmission unit transmits malfunction information to the base station apparatus in a case where the terminal apparatus determines that the terminal apparatus has a malfunction.

### TECHNICAL FIELD

The present invention relates to a terminal apparatus, a base station apparatus, and a communication method.

### BACKGROUND ART

Along with advances in radio communication technology, there have recently been studies on the collection of a large amount of data by distributing a number of sensors. Long Term Evolution (LTE) and LTE-Advanced (LTE-A) established by 3rd Generation Partnership Project (3GPP) are representative radio communication standards that are attracting attention as a standard capable of dealing with continuously increasing radio traffic. Details are described in NPL 1.

### CITATION LIST

### Non Patent Literature

NPL 1: 3GPP TS 36.300 V12.5.0, “3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 12)”, 2015, March.

### SUMMARY OF INVENTION

### Technical Problem

In the method described in NPL 1, batteries in small-size terminals such as sensors quickly discharge due to high power consumption. Thus, a problem arises in that it is difficult to distribute a number of sensors. In addition, in a case where any of a number of distributed sensors has a malfunction, a problem arises in that it is difficult to find the sensor that has a malfunction.

The present invention is conceived in view of such matters. An object of the present invention is to provide a terminal apparatus, a base station apparatus, and a communication method capable of collecting data with reduced power consumption and finding a malfunction.

### Solution to Problem

Configurations of a terminal apparatus, a base station apparatus, and a communication method according to one aspect of the present invention for resolving the problems are as follows.

A terminal apparatus according to one aspect of the present invention includes a reception unit that receives a radio parameter and malfunction information from a base station apparatus, a connection unit that makes connection to an end terminal apparatus including a data transmission function and transmits a parameter including the radio parameter to the end terminal apparatus, and a display unit that displays position information of an end terminal apparatus having a malfunction in a case where the malfunction information is received.

A terminal apparatus according to one aspect of the present invention includes a connection unit that makes connection to a control terminal apparatus including a function of performing radio communication with a base station apparatus and receives a radio parameter from the control terminal apparatus, and a transmission unit that transmits a data signal to the base station apparatus using the radio parameter. The transmission unit transmits malfunction information to the base station apparatus in a case where the terminal apparatus determines that the terminal apparatus has a malfunction.

In the terminal apparatus according to one aspect of the present invention, the malfunction information is information related to a sensor or a battery.

A base station apparatus according to one aspect of the present invention is a base station apparatus that communicates with a control terminal apparatus and an end terminal apparatus. The base station apparatus includes a transmission unit that transmits a radio parameter to the control terminal apparatus, and a reception unit that receives a data signal transmitted using the radio parameter from the end terminal apparatus. The base station apparatus transmits malfunction information to the control terminal apparatus in a case where the base station apparatus determines that the end terminal apparatus has a malfunction.

In the base station apparatus according to one aspect of the present invention, the radio parameter includes a period of data transmission, and the base station apparatus determines that the end terminal apparatus has the malfunction in a case where the base station apparatus does not receive the data signal from the end terminal apparatus in the period.

In the base station apparatus according to one aspect of the present invention, the base station apparatus determines the malfunction from the data signal received from the end terminal apparatus.

In the base station apparatus according to one aspect of the present invention, the base station apparatus receives a signal indicating the malfunction from the end terminal apparatus and determines the malfunction from the signal indicating the malfunction.

In the base station apparatus according to one aspect of the present invention, the malfunction information includes at least one of information related to communication, information of a sensor, or information of a battery.

A communication method according to one aspect of the present invention is a communication method that is implemented in a terminal apparatus. The communication method includes a reception step of receiving a radio parameter and malfunction information from a base station apparatus, a connection step of making connection to an end terminal apparatus including a data transmission function, and transmitting a parameter including the radio parameter to the end terminal apparatus, and a display step of displaying position information of an end terminal apparatus having a malfunction in a case where the malfunction information is received.

A communication method according to one aspect of the present invention is a communication method that is implemented in a terminal apparatus. The communication method includes a connection step of making connection to a control terminal apparatus including a function of performing radio communication with a base station apparatus, and receiving a radio parameter from the control terminal apparatus, and a transmission step of transmitting a data signal to the base station apparatus using the radio parameter. In the transmission step, malfunction information is transmitted to the base station apparatus in a case where a determination is made that the terminal apparatus has a malfunction.

A communication method according to one aspect of the present invention is a communication method that is implemented in a base station apparatus communicating with a control terminal apparatus and an end terminal apparatus. The communication method includes a transmission step of transmitting a radio parameter to the control terminal apparatus, and a reception step of receiving a data signal transmitted using the radio parameter from the end terminal apparatus. Malfunction information is transmitted to the control terminal apparatus in a case where a determination is made that the end terminal apparatus has a malfunction.

### Advantageous Effects of Invention

According to one aspect of the present invention, the terminal apparatus can reduce power consumption and recognize the malfunction information.

### BRIEF DESCRIPTION OF DRAWINGS

FIG. 1 is a diagram illustrating an example of a communication system according to the present embodiment.

FIG. 2 is a diagram illustrating an example of the communication system according to the present embodiment.

FIG. 3 is a diagram illustrating a flow of process of a base station apparatus in the present embodiment.

FIG. 4 is a schematic block diagram illustrating a configuration of a first terminal apparatus in the present embodiment.

FIG. 5 is a schematic block diagram illustrating a configuration of a second terminal apparatus in the present embodiment.

### DESCRIPTION OF EMBODIMENTS

A communication system in the present embodiment includes a base station apparatus (transmission apparatus, cell, transmission point, transmit antenna group, transmit antenna port group, component carrier, or eNodeB) and a terminal apparatus (terminal, mobile terminal, reception point, reception terminal, reception apparatus, receive antenna group, receive antenna port group, or UE).

In the present embodiment, “X/Y” includes the meaning of “X or Y”. In the present embodiment, “X/Y” includes the meaning of “X and Y”. In the present embodiment, “X/Y” includes the meaning of “X and/or Y”.

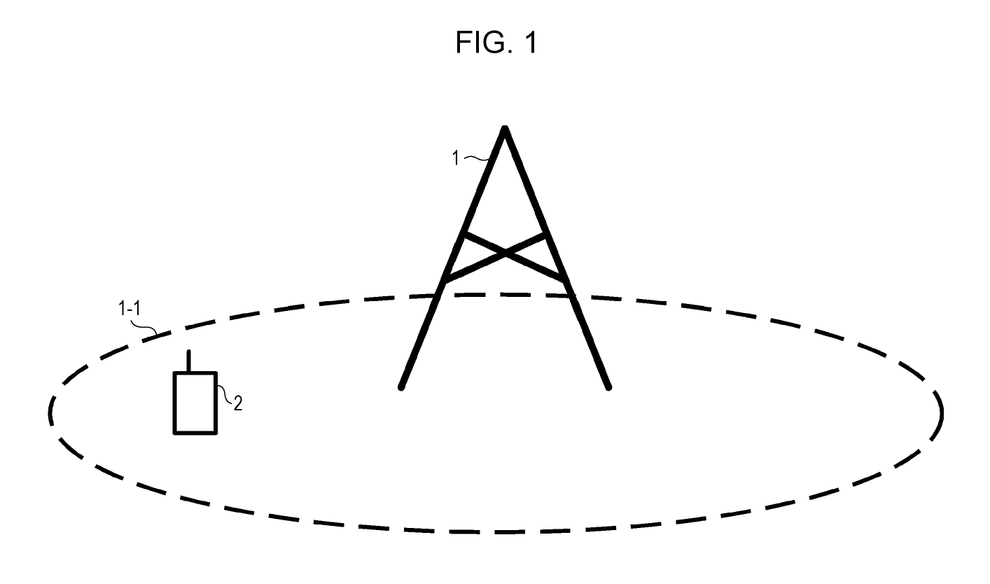

FIG. 1 is a diagram illustrating an example of the communication system according to the present embodiment. As illustrated in FIG. 1, the communication system in the present embodiment includes a base station apparatus 1 and a terminal apparatus 2. A coverage 1-1 is a range (communication area) in which the base station apparatus 1 can be connected to the terminal apparatus.

In uplink radio communication to the base station apparatus 1 from the terminal apparatus 2 in FIG. 1, the following physical uplink channels are used. Each physical uplink channel is used for transmitting information that is output from a higher layer.
Physical uplink control channel (PUCCH)
Physical uplink shared channel (PUSCH)
Physical random access channel (PRACH)

PUCCH is used for transmitting uplink control information (UCI). Here, the uplink control information includes a positive acknowledgment (ACK) or a negative acknowledgment (NACK) (ACK/NACK) for downlink data (downlink transport block or downlink-shared channel (DL-SCH)). ACK/NACK for the downlink data is referred to as HARQ-ACK or HARQ feedback.

The uplink control information includes channel state information (CSI) for downlink. The uplink control information includes a scheduling request (SR) that is used for requesting a resource of an uplink shared channel (UL-SCH).

PUSCH is used for transmitting uplink data (uplink transport block or UL-SCH). PUSCH may be used for transmitting ACK/NACK and/or the channel state information along with the uplink data. PUSCH may be used for transmitting only the uplink control information.

PUSCH is used for transmitting an RRC message. The RRC message is information/signal that is processed in a radio resource control (RRC) layer. PUSCH is used for transmitting a MAC control element (CE). Here, MAC CE is information/signal that is processed (transmitted) in a medium access control (MAC) layer.

For example, power headroom may be included in MAC CE and reported via PUSCH. That is, a field of MAC CE may be used for indicating the level of power headroom.

PRACH is used for transmitting a random access preamble.

In uplink radio communication, an uplink reference signal (UL RS) is used as a physical uplink signal. The physical uplink signal is not used for transmitting information output from a higher layer but is used in a physical layer. Here, the uplink reference signal includes a demodulation reference signal (DMRS) and a sounding reference signal (SRS).

DMRS is associated with transmission of PUSCH or PUCCH. For example, the base station apparatus 1 uses DMRS for correcting the propagation channel of PUSCH or PUCCH. SRS is not associated with transmission of PUSCH or PUCCH. For example, the base station apparatus 1 uses SRS for measuring the channel state of uplink.

In downlink radio communication to the terminal apparatus 2 from the base station apparatus 1 in FIG. 1, the following physical downlink channels are used. Each physical downlink channel is used for transmitting information that is output from a higher layer.
Physical broadcast channel (PBCH)
Physical control format indicator channel (PCFICH)
Physical hybrid automatic repeat request indicator channel (PHICH)
Physical downlink control channel (PDCCH)
Enhanced physical downlink control channel (EPDCCH)
Physical downlink shared channel (PDSCH)

PBCH is used for broadcasting a master information block (MIB; broadcast channel (BCH)) that is used in the terminal apparatus 2. PCFICH is used for transmitting information that specifies a region (for example, the number of OFDM symbols) used for transmission of PDCCH.

PHICH is used for transmitting ACK/NACK for the uplink data received by the base station apparatus 1. That is, PHICH is used for transmitting an HARQ indicator (HARQ feedback) that indicates ACK/NACK for the uplink data.

PDCCH and EPDCCH are used for transmitting downlink control information (DCI). Here, a plurality of DCI formats is defined for the transmission of the downlink control information. That is, a field for the downlink control information is defined as a DCI format and mapped to an information bit.

For example, a DCI format 1A that is used in scheduling of one PDSCH (transmission of one downlink transport block) in one cell is defined as a DCI format for downlink.

For example, the DCI format for downlink includes information related to PDSCH resource assignment, information related to a modulation and coding scheme (MCS) for PDSCH, and the downlink control information such as a TPC command for PUCCH. Here, the DCI format for downlink is also referred to as a downlink grant (or downlink assignment).

For example, a DCI format 0 that is used in scheduling of one PUSCH (transmission of one uplink transport block) in one cell is defined as a DCI format for uplink.

For example, the DCI format for uplink includes information related to PUSCH resource assignment, information related to MCS for PUSCH, and the uplink control information such as a TPC command for PUSCH. The DCI format for uplink is also referred to as an uplink grant (or uplink assignment).

The DCI format for uplink can be used for requesting the channel state information (CSI; also referred to as reception quality information) for downlink (CSI request). The channel state information corresponds to a rank indicator RI that specifies a suitable number of spatial multiplexing, a precoding matrix indicator PMI that specifies a suitable precoder, a channel quality indicator CQI that specifies a suitable transfer rate, and the like.

The DCI format for uplink can be used for a configuration that indicates an uplink resource to which a channel state information report (CSI feedback report or CSI reporting) to be provided as feedback to the base station apparatus by the terminal apparatus is mapped. For example, the channel state information report can be used for a configuration that indicates an uplink resource for regularly (periodically) reporting the channel state information (periodic CSI). The channel state information report can be used for configuring a mode of regularly reporting the channel state information (CSI report mode).

For example, the channel state information report can be used for a configuration that indicates an uplink resource for irregularly (aperiodically) reporting the channel state information (aperiodic CSI). The channel state information report can be used for configuring a mode of irregularly reporting the channel state information (CSI reporting mode). The base station apparatus 1 can configure either the regular channel state information report or the irregular channel state information report. The base station apparatus 1 can configure both of the regular channel state information report and the irregular channel state information report.

The DCI format for uplink can be used for a configuration that indicates the type of the channel state information report to be provided as feedback to the base station apparatus by the terminal apparatus. Types of channel state information reports are wideband CSI (for example, wideband CQI), subband CSI (for example, subband CQI), and the like.

The DCI format for uplink can be used for configuring a mode that includes the regular channel state information report or the irregular channel state information report and the type of the channel state information report. For example, a mode of reporting the irregular channel state information report and wideband CSI, a mode of reporting the irregular channel state information report and subband CSI, a mode of reporting the irregular channel state information report, and wideband CSI and subband CSI, a mode of reporting the regular channel state information report and wideband CSI, a mode of reporting the regular channel state information report and subband CSI, a mode of reporting the regular channel state information report, and wideband CSI and subband CSI, and the like are configured.

In a case where the resource of PDSCH is scheduled using the downlink assignment, the terminal apparatus 2 receives the downlink data through scheduled PDSCH. In a case where the resource of PUSCH is scheduled using the uplink grant, the terminal apparatus 2 transmits the uplink data and/or the uplink control information through scheduled PUSCH.

PDSCH is used for transmitting the downlink data (downlink transport block or DL-SCH). PDSCH is used for transmitting a system information block type 1 message. The system information block type 1 message is cell-specific (unique to cell) information.

PDSCH is used for transmitting a system information message. The system information message includes a system information block X other than a system information block type 1. The system information message is cell-specific (unique to cell) information.

PDSCH is used for transmitting the RRC message. Here, the RRC message transmitted from the base station apparatus 1 may be used in common among a plurality of terminal apparatuses 2 in a cell. The RRC message transmitted from the base station apparatus 1 may be a dedicated message (also referred to as dedicated signaling) for a certain terminal apparatus 2. That is, user-apparatus-specific (unique to user apparatus) information is transmitted using a dedicated message for a certain terminal apparatus 2. PDSCH is used for transmitting MAC CE.

Here, the RRC message and/or MAC CE is also referred to as a signal in a higher layer (higher layer signaling).

In downlink radio communication, a synchronization signal (SS) and a downlink reference signal (DL RS) are used as physical downlink signals. The physical downlink signal is not used for transmitting information output from a higher layer but is used in the physical layer.

The terminal apparatus 2 uses the synchronization signal for synchronizing in a frequency domain and a time domain in downlink. The terminal apparatus 2 uses the downlink reference signal for correcting the propagation channel of the physical downlink channel. For example, the terminal apparatus 2 uses the downlink reference signal for calculating the channel state information of downlink.

Here, the downlink reference signal includes a cell-specific reference signal (CRS), a UE-specific reference signal (UERS) associated with PDSCH, a demodulation reference signal (DMRS) associated with EPDCCH, a non-zero power channel state information-reference signal (NZP CSI-RS), and a zero power channel state information-reference signal (ZP CSI-RS).

CRS is transmitted in all bands of subframes and is used for demodulating PBCH/PDCCH/PHICH/PCFICH/PDSCH. URS that is associated with PDSCH is transmitted in a subframe and a band that are used for transmission of PDSCH associated with URS. URS is used for demodulating PDSCH associated with URS.

DMRS that is associated with EPDCCH is transmitted in a subframe and a band that are used for transmission of EPDCCH associated with DMRS. DMRS is used for demodulating EPDCCH associated with DMRS.

The resource of NZP CSI-RS is configured by the base station apparatus 1. For example, the terminal apparatus 2 measures a signal (measures a channel) using NZP CSI-RS. The resource of ZP CSI-RS is configured by the base station apparatus 1. The base station apparatus 1 transmits ZP CSI-RS as a zero output. For example, the terminal apparatus 2 measures interference in the resource corresponding to NZP CSI-RS.

Here, the physical downlink channel and the physical downlink signal are also collectively referred to as a downlink signal. The physical uplink channel and the physical uplink signal are also collectively referred to as an uplink signal. The physical downlink channel and the physical uplink channel are also collectively referred to as a physical channel. The physical downlink signal and the physical uplink signal are also collectively referred to as a physical signal.

BCH, UL-SCH, and DL-SCH are transport channels. A channel used in the MAC layer is referred to as a transport channel. The unit of the transport channel used in the MAC layer is referred to as a transport block (TB) or a MAC protocol data unit (PDU). The transport block is the unit of data passed (delivered) to the physical layer by the MAC layer. In the physical layer, the transport block is mapped to a code word, and a coding process and the like are performed per code word.

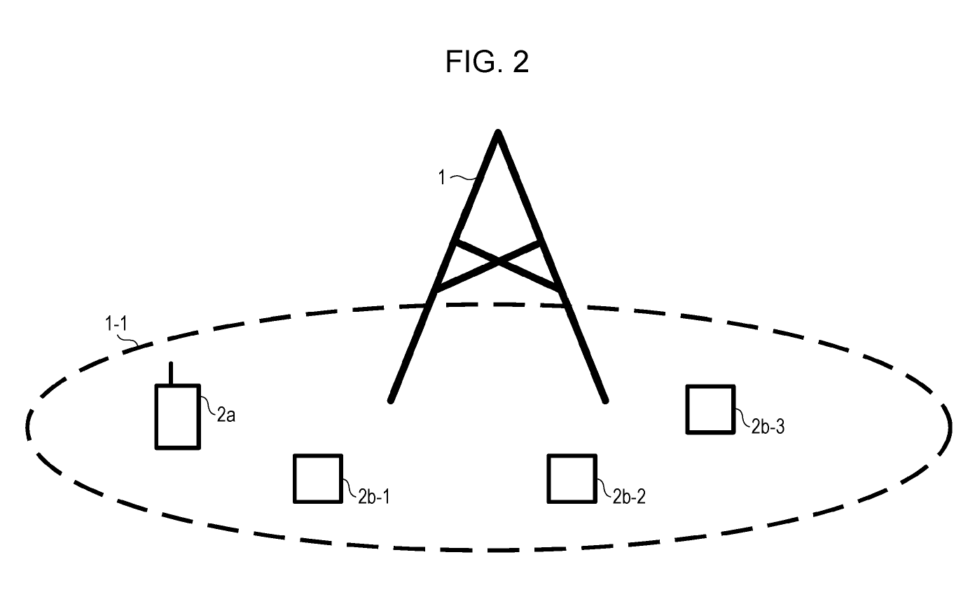

FIG. 2 is a diagram illustrating an example of the communication system according to the present embodiment. As illustrated in FIG. 2, the communication system in the present embodiment includes the base station apparatus 1, a first terminal apparatus (control terminal apparatus) 2a, and second terminal apparatuses 2b-1, 2b-2, and 2b-3. The second terminal apparatuses (end terminal apparatuses) 2b-1, 2b-2, and 2b-3 are also collectively referred to as a second terminal apparatus 2b. For example, the second terminal apparatus can be used as a sensor. The number of second terminal apparatuses 2b is three in the drawing but may be other than three.

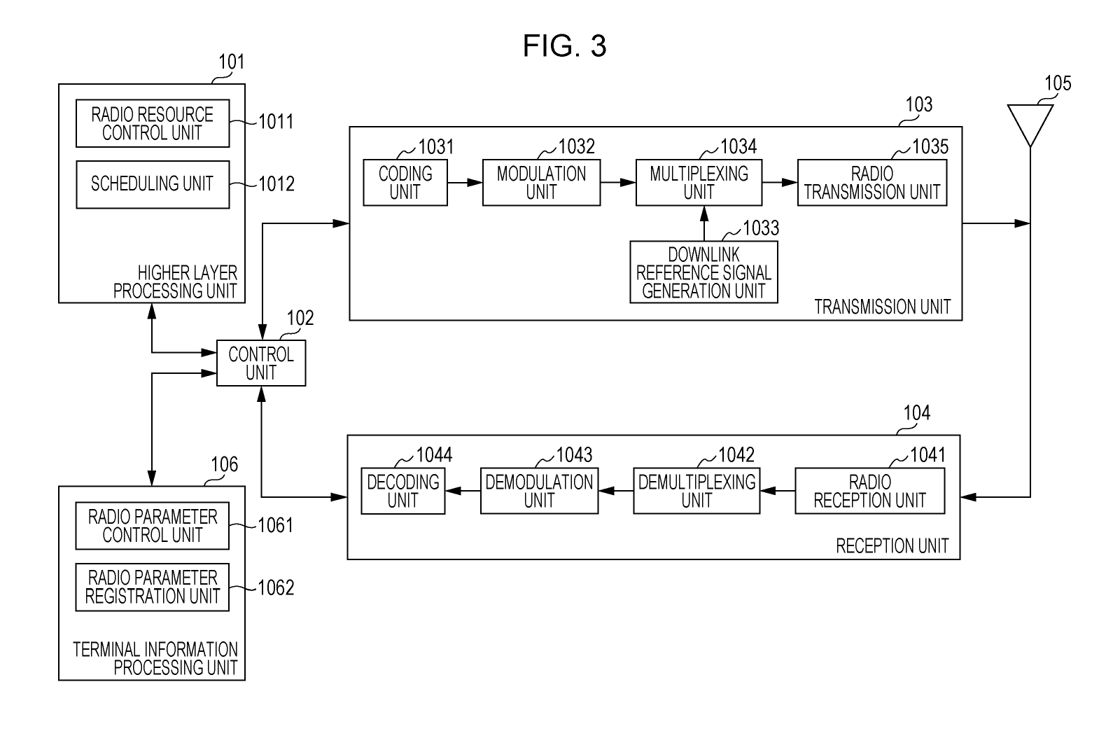

FIG. 3 is a schematic block diagram illustrating a configuration of the base station apparatus in the present embodiment. As illustrated in FIG. 3, the base station apparatus is configured to include a higher layer processing unit 101, a control unit 102, a transmission unit 103, a reception unit 104, a transmit and receive antenna 105, and a terminal information processing unit 106. The higher layer processing unit 101 is configured to include a radio resource control unit 1011 and a scheduling unit 1012. The transmission unit 103 is configured to include a coding unit 1031, a modulation unit 1032, a downlink reference signal generation unit 1033, a multiplexing unit 1034, and a radio transmission unit 1035. The reception unit 104 is configured to include a radio reception unit 1041, a demultiplexing unit 1042, a demodulation unit 1043, and a decoding unit 1044. The terminal information processing unit 106 is configured to include a radio parameter control unit 1061 and a radio parameter registration unit 1062.

The higher layer processing unit 101 performs processes in the medium access control (MAC) layer, a packet data convergence protocol (PDCP) layer, a radio link control (RLC) layer, and the radio resource control (RRC) layer. In addition, the higher layer processing unit 101 generates information used for controlling the transmission unit 103 and the reception unit 104 and outputs the information to the control unit 102.

The higher layer processing unit 101 receives information related to the terminal apparatus such as the function of the terminal apparatus (UE capability) from the terminal apparatus. In other words, the terminal apparatus transmits the function of the terminal apparatus to the base station apparatus using a higher layer signal.

In the following description, the information related to the terminal apparatus includes either information that indicates whether or not the terminal apparatus supports a prescribed function, or information that indicates that introduction and testing of a prescribed function of the terminal apparatus are completed. In the following description, whether or not a prescribed function is supported includes whether or not introduction and testing of a prescribed function are completed. For example, in a case where the terminal apparatus supports a prescribed function, the information indicating whether or not the terminal apparatus supports the prescribed function, or the information indicating that introduction and testing of the prescribed function of the terminal apparatus are completed is transmitted. In a case where the terminal apparatus does not support a prescribed function, the information indicating whether or not the terminal apparatus supports the prescribed function, or the information indicating that introduction and testing of the prescribed function of the terminal apparatus are completed is not transmitted. That is, whether or not the information indicating whether or not the terminal apparatus supports a prescribed function, or the information indicating that introduction and testing of a prescribed function of the terminal apparatus are completed is transmitted indicates whether or not the terminal apparatus supports the prescribed function.

For example, in a case where the terminal apparatus supports a prescribed function, the terminal apparatus transmits the information (parameter) indicating whether or not the prescribed function is supported. In a case where the terminal apparatus does not support a prescribed function, the terminal apparatus does not transmit the information (parameter) indicating whether or not the prescribed function is supported. That is, whether or not the prescribed function is supported is notified according to whether or not the information (parameter) indicating whether or not the prescribed function is supported is transmitted. The information (parameter) indicating whether or not a prescribed function is supported may be notified using one bit of 1 or 0.

The radio resource control unit 1011 generates, or acquires from a higher node, the downlink data (transport block) arranged in PDSCH in downlink, system information, the RRC message, MAC CE, and the like. The radio resource control unit 1011 outputs the downlink data to the transmission unit 103 and outputs other information to the control unit 102. The radio resource control unit 1011 manages various configuration information of the terminal apparatus 2.

The scheduling unit 1012 generates information used in scheduling of the physical channel (PDSCH and PUSCH) based on a scheduling result. The scheduling unit 1012 outputs the generated information to the control unit 102.

The control unit 102 generates control signals for controlling the transmission unit 103 and the reception unit 104 based on the information input from the higher layer processing unit 101. The control unit 102 determines MCS based on the information input from the higher layer processing unit 101. The control unit 102 determines the number of code words based on the information input from the higher layer processing unit 101. The control unit 102 determines the number of layers, an antenna port number, and a scrambling identity based on the information input from the higher layer processing unit 101.

The control unit 102 generates the downlink control information based on the information input from the higher layer processing unit 101 and outputs the downlink control information to the transmission unit 103. In a case where the base station apparatus is a primary cell, configuration information of a higher layer of a secondary cell may be included in the downlink control information.

The control unit 102 can include a radio parameter used by the second terminal apparatus in the downlink signal based on information input from the terminal information processing unit 106.

In accordance with the control signal input from the control unit 102, the transmission unit 103 generates the downlink reference signal, codes and modulates the HARQ indicator, the downlink control information, and the downlink data input from the higher layer processing unit 101, multiplexes PHICH, PDCCH, EPDCCH, PDSCH, and the downlink reference signal, and transmits the signal to the terminal apparatus 2 through the transmit and receive antenna 105. In a case where the base station apparatus uses a second frame structure, the base station apparatus can multiplex at least PDSCH and may not multiplex the downlink control information. The frequency interval/time interval between downlink reference signals in the second frame structure can be increased further than in a first frame structure. The base station apparatus can transmit control information of a signal assigned to the second frame structure using the first frame structure.

The coding unit 1031 codes the HARQ indicator, the downlink control information, and the downlink data input from the higher layer processing unit 101 using a predetermined coding scheme such as block coding, convolutional coding, and turbo coding, or a coding scheme determined by the radio resource control unit 1011.

The modulation unit 1032 modulates coding bits input from the coding unit 1031 using a predetermined modulation scheme such as binary phase shift keying (BPSK), quadrature phase shift keying (QPSK), 16 quadrature amplitude modulation (QAM), 64 QAM, and 256 QAM, or a modulation scheme determined by the radio resource control unit 1011.

The downlink reference signal generation unit 1033 generates, as the downlink reference signal, a sequence that is previously known to the terminal apparatus 2 and is acquired using a predetermined rule based on a physical cell identity (PCI) and the like for identifying the base station apparatus 1. The downlink reference signal generation unit 1033 can generate DMRS based on the scrambling identity.

The multiplexing unit 1034 multiplexes a modulation symbol of each modulated channel with the generated downlink reference signal and the downlink control information. That is, the multiplexing unit 1034 arranges the modulation symbol of each modulated channel, the downlink reference signal, and the downlink control information in a resource element.

The radio transmission unit 1035 performs an inverse fast Fourier transform (IFFT) of the multiplexed modulation symbol and the like to perform modulation using the OFDM scheme, and attaches a cyclic prefix (CP) to the OFDM symbol modulated using OFDM to generate a baseband digital signal. The radio transmission unit 1035 converts the generated baseband digital signal into an analog signal in a desired band using filtering, digital-to-analog (DA) conversion, frequency conversion, power amplification, and the like. The radio transmission unit 1035 outputs the generated analog signal to the transmit and receive antenna 105 to transmit the analog signal.

In accordance with the control signal input from the control unit 102, the reception unit 104 demultiplexes, demodulates, and decodes a received signal received from the terminal apparatus 2 through the transmit and receive antenna 105, and outputs the decoded information to the higher layer processing unit 101.

The radio reception unit 1041 converts the uplink signal received through the transmit and receive antenna 105 into a baseband digital signal using frequency conversion, filtering, analog-to-digital (AD) conversion, amplitude control, and the like.

The radio reception unit 1041 removes a part corresponding to CP from the converted digital signal. For the signal after CP is removed, the radio reception unit 1041 performs a fast Fourier transform (FFT) to extract a signal in the frequency domain and outputs the signal to the demultiplexing unit 1042.

The demultiplexing unit 1042 demultiplexes the signal input from the radio reception unit 1041 into signals of PUCCH, PUSCH, the uplink reference signal, and the like. This demultiplexing is performed based on radio resource assignment information that is determined in advance in the radio resource control unit 1011 by the base station apparatus 1 and is included in the uplink grant notified to each terminal apparatus 2.

The demultiplexing unit 1042 compensates the propagation channel of each of PUCCH and PUSCH. The demultiplexing unit 1042 demultiplexes the uplink reference signal.

The demodulation unit 1043 performs an inverse discrete Fourier transform (IDFT) of PUSCH to acquire a modulation symbol. For each modulation symbol of PUCCH and PUSCH, the demodulation unit 1043 uses a predetermined modulation scheme such as BPSK, QPSK, 16 QAM, 64 QAM, and 256 QAM, or a modulation scheme that is notified in advance by the base station apparatus 1 to each terminal apparatus 2 using the uplink grant, to demodulate the received signal. The inverse discrete Fourier transform may be an inverse fast Fourier transform corresponding to the number of subcarriers of PUSCH.

The decoding unit 1044 decodes the demodulated coding bits of PUCCH and PUSCH using a predetermined coding scheme at a predetermined coding rate or a coding rate that is notified in advance by the base station apparatus 1 to the terminal apparatus 2 using the uplink grant. The decoding unit 1044 outputs the decoded uplink data and the uplink control information to the higher layer processing unit 101. In a case where PUSCH is transmitted again, the decoding unit 1044 performs decoding using the demodulated coding bit and a coding bit that is input from the higher layer processing unit 101 and retained in a HARQ buffer.

In a case where information decoded in the decoding unit 1044 includes a connectivity request from the second terminal apparatus 2b, the control unit 102 outputs the information to the terminal information processing unit 106.

The terminal information processing unit 106 determines the radio parameter of the second terminal apparatus 2b. For example, the radio parameter control unit 1061 can determine the radio parameter of the second terminal apparatus 2b. This determination can be performed based on terminal information that is previously registered. The radio parameter control unit 1061 outputs information of the determined radio parameter to the control unit 102 in order to transmit the determined radio parameter to the second terminal apparatus 2b.

The radio parameter registration unit 1062 registers the radio parameter determined in the radio parameter control unit 1061 as the terminal information. The radio parameter control unit 1061 and the like can read the registered terminal information.

The radio parameter includes a part or all of a frequency band used in communication to the base station apparatus 1 from the second terminal apparatus 2b, a subcarrier used by the second terminal apparatus 2b, a time interval between transmissions performed by the second terminal apparatus 2b, transmit power of the second terminal apparatus 2b, the position of the second terminal apparatus 2b, a subcarrier interval of the second terminal apparatus 2b, whether or not filtering is performed, the antenna port number, an assigned bandwidth, and the like. For example, the position of the first terminal apparatus 2a in a state of being connected to the second terminal apparatus 2b can be used as the position of the second terminal apparatus 2b. The radio parameter control unit 1061 can assign one subcarrier to each second terminal apparatus 2b. The assigned subcarrier can be chosen from subcarriers that are not assigned to any second terminal apparatus yet. The radio parameter control unit 1061 can assign one resource block to each second terminal apparatus 2b. The assigned resource block can be chosen from resource blocks that are not assigned to any second terminal apparatus yet. The radio parameter control unit 1061 can assign a plurality of subcarriers to each second terminal apparatus 2b. The plurality of assigned subcarriers can be chosen from subcarriers that are not assigned to any second terminal apparatus 2b yet. The radio parameter control unit 1061 can assign the antenna port number to each second terminal apparatus 2b. The radio parameter control unit 1061 can assign a different subcarrier interval to any second terminal apparatus 2b. The radio parameter control unit 1061 can choose whether or not filtering is performed for each second terminal apparatus 2b. The second terminal apparatus 2b in which filtering is configured can transmit signals on which filtering is performed for the number or bandwidth of assigned subcarriers or resource blocks.

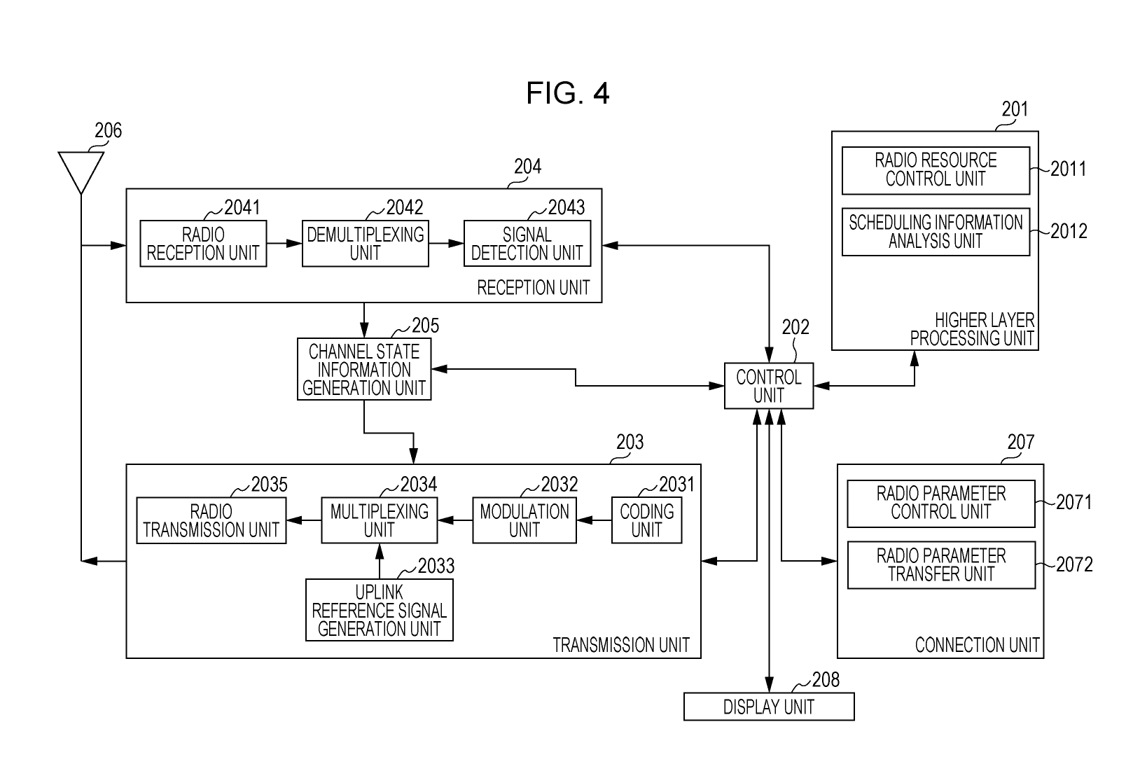

FIG. 4 is a schematic block diagram illustrating a configuration of the first terminal apparatus 2a in the present embodiment. As illustrated in FIG. 4, the terminal apparatus is configured to include a higher layer processing unit 201, a control unit 202, a transmission unit 203, a reception unit 204, a channel state information generation unit 205, a transmit and receive antenna 206, a connection unit 207, and a display unit 208. The higher layer processing unit 201 is configured to include a radio resource control unit 2011 and a scheduling information analysis unit 2012. The transmission unit 203 is configured to include a coding unit 2031, a modulation unit 2032, an uplink reference signal generation unit 2033, a multiplexing unit 2034, and a radio transmission unit 2035. The reception unit 204 is configured to include a radio reception unit 2041, a demultiplexing unit 2042, and a signal detection unit 2043. The connection unit 207 is configured to include a radio parameter control unit 2071 and a radio parameter transfer unit 2072. The connection unit 207 can be connected to the second terminal apparatus 2b. This connection can be realized as direct connection, wired connection, or wireless connection. In a case where the connection is realized as wireless connection, communication to the second terminal apparatus 2b from the first terminal apparatus 2a can be performed using the downlink signal in PDSCH. Communication to the first terminal apparatus 2a from the second terminal apparatus 2b can be performed using the uplink signal in PUSCH. Communication between the first terminal apparatus 2a and the second terminal apparatus 2b can be performed using device-to-device (D2D) communication. The same applies to the following description. In a case where communication is performed between terminals, the following physical channels can be used.
Physical sidelink broadcast channel (PSBCH)
Physical sidelink control channel (PSCCH)
Physical sidelink discovery channel (PSDCH)
Physical sidelink shared channel (PSSCH)

PSBCH is used for notifying the system information and information associated with synchronization. PSDCH is used for notifying a sidelink direct discovery message for discovering a neighboring (adjacent) terminal. PSSCH is used for notifying user data in sidelink direct communication. PSCCH is used for notifying control information in sidelink direct communication. In the case of terminal-to-terminal communication (sidelink communication), the terminal apparatus can communicate using a resource group (resource pool) for terminal-to-terminal communication. The terminal apparatus can communicate using a resource specified by the base station apparatus or a resource chosen by the terminal apparatus in the resource pool.

The higher layer processing unit 201 outputs the uplink data (transport block) generated by an operation and the like of a user to the transmission unit 203. The higher layer processing unit 201 performs processing in the medium access control (MAC) layer, the packet data convergence protocol (PDCP) layer, the radio link control (RLC) layer, and the radio resource control (RRC) layer.

The higher layer processing unit 201 outputs information indicating the function of the terminal apparatus supported by the terminal apparatus to the transmission unit 203.

The radio resource control unit 2011 manages various configuration information of the terminal apparatus. The radio resource control unit 2011 generates information to be arranged in each channel of uplink and outputs the information to the transmission unit 203.

The scheduling information analysis unit 2012 analyzes the downlink control information received through the reception unit 204 and determines scheduling information. The scheduling information analysis unit 2012 can determine whether or not NOMA is performed on a resource element to be transmitted to the terminal apparatus. The scheduling information analysis unit 2012 generates control information for controlling the reception unit 204 and the transmission unit 203 based on the scheduling information, and outputs the control information to the control unit 202.

The control unit 202 generates control signals for controlling the reception unit 204 and the transmission unit 203 based on the information input from the higher layer processing unit 201. The control unit 202 outputs the generated control signals to the reception unit 204 and the transmission unit 203 to control the reception unit 204 and the transmission unit 203. The control unit 202 outputs the uplink data and the uplink control information including the terminal information and the like to the transmission unit 203.

The control unit 202 controls the transmission unit 203 to transmit CSI generated by the channel state information generation unit 205 to the base station apparatus.

In a case where a connectivity request to the base station apparatus 1 from the second terminal apparatus 2b is received by the control unit 202 from the connection unit 207, the control unit 202 can include the request in the uplink signal.

In accordance with the control signal input from the control unit 202, the reception unit 204 demultiplexes, demodulates, and decodes the received signal received from the base station apparatus through the transmit and receive antenna 206, and outputs the decoded information to the higher layer processing unit 201.

The radio reception unit 2041 converts the downlink signal received through the transmit and receive antenna 206 into a baseband digital signal using frequency conversion, filtering, AD conversion, amplitude control, and the like.

The radio reception unit 2041 removes a part corresponding to CP from the converted digital signal. For the signal after CP is removed, the radio reception unit 2041 performs a fast Fourier transform to extract a signal in the frequency domain.

The demultiplexing unit 2042 demultiplexes the extracted signal into PHICH, PDCCH, EPDCCH, PDSCH, and/or the downlink reference signal. The demultiplexing unit 2042 compensates the channels of PHICH, PDCCH, and EPDCCH based on an estimated value of a channel of a desired signal acquired from channel measurement. The demultiplexing unit 2042 detects the downlink control information, and outputs the downlink control information to the control unit 202. In a case where the received signal is a signal transmitted using the second frame structure, and where the downlink control information is not transmitted in the second frame structure, the demultiplexing unit 2042 does not detect the downlink control information. The control unit 202 outputs PDSCH and the estimated value of the channel of the desired signal to the signal detection unit 2043.

The signal detection unit 2043 detects the downlink data (transport block) using PDSCH and the estimated value of the channel, and outputs the downlink data to the higher layer processing unit 201.

In accordance with the control signal input from the control unit 202, the transmission unit 203 generates the uplink reference signal, and codes and modulates the uplink data (transport block) input from the higher layer processing unit 201. The transmission unit 203 multiplexes PUCCH, PUSCH, and the generated uplink reference signal and transmits the multiplexed signal to the base station apparatus through the transmit and receive antenna 206.

The coding unit 2031 codes the uplink control information input from the higher layer processing unit 201 using convolutional coding, block coding, and the like. The coding unit 2031 performs turbo coding based on information that is used in scheduling of PUSCH.

The modulation unit 2032 modulates a coding bit input from the coding unit 2031 using a modulation scheme such as BPSK, QPSK, 16 QAM, and 64 QAM notified in the downlink control information, or a predetermined modulation scheme for each channel.

The uplink reference signal generation unit 2033 generates a sequence that is acquired using a predetermined rule (formula), based on the physical cell identity (PCI; referred to as cell ID and the like) for identifying the base station apparatus 1, a bandwidth in which the uplink reference signal is to be arranged, a cyclic shift notified in the uplink grant, the value of a parameter for generating a DMRS sequence, and the like.

In accordance with the control signal input from the control unit 202, the multiplexing unit 2034 arranges modulation symbols of PUSCH in parallel and performs a discrete Fourier transform (DFT). The multiplexing unit 2034 multiplexes signals of PUCCH and PUSCH with the generated uplink reference signal for each transmit antenna port. That is, the multiplexing unit 2034 arranges signals of PUCCH and PUSCH and the generated uplink reference signal in a resource element for each transmit antenna port. The discrete Fourier transform may be a fast Fourier transform corresponding to the number of subcarriers of PUCCH or PUSCH.

The radio transmission unit 2035 performs an inverse fast Fourier transform of the multiplexed signal to modulate the multiplexed signal using the SC-FDMA scheme and generates an SC-FDMA symbol. The radio transmission unit 2035 attaches CP to the generated SC-FDMA symbol to generate a baseband digital signal. The radio transmission unit 2035 converts the generated baseband digital signal into an analog signal in a desired band using filtering, DA conversion, frequency conversion, power amplification, and the like. The radio transmission unit 2035 outputs the generated analog signal to the transmit and receive antenna 206 to transmit the analog signal.

The radio parameter control unit 2071 detects the radio parameter that is used by the second terminal apparatus 2b and included in the downlink signal from the base station apparatus 1. The radio parameter transfer unit 2072 transfers the radio parameter to the second terminal apparatus 2b to which the first terminal apparatus 2a is connected.

The display unit 208 can display malfunction information (error information) of the second terminal apparatus 2b. For example, the base station apparatus 1 can determine that the second terminal apparatus 2b has a malfunction in a case where a signal of a subcarrier assigned to the second terminal apparatus 2b does not arrive at a predetermined timing or at a timing within an allowable range. In this case, the transmission unit 103 of the base station apparatus 1 can transmit the malfunction information of the second terminal apparatus 2b to the reception unit of the first terminal apparatus 2a. For example, the display unit 208 can display position information of the second terminal apparatus 2b that is configured in the malfunction information. In a case where the second terminal apparatus 2b may not transmit data at a predetermined timing due to a version upgrade or the like, the second terminal apparatus 2b can transmit a signal (information) indicating the incapability of transmitting data or a dummy signal in advance. In a case where the base station apparatus 1 receives a specific signal (information) from the second terminal apparatus 2b, the base station apparatus 1 does not determine that the second terminal apparatus 2b has a malfunction even when a signal is not received from the second terminal apparatus 2b at a predetermined timing. The first terminal apparatus 2a can receive the malfunction information from the second terminal apparatus 2b. In this case, the first terminal apparatus 2a can transmit the malfunction information to the base station apparatus 1. The second terminal apparatus 2b can transmit the malfunction information to the base station apparatus 1. The second terminal apparatus 2b can transmit the malfunction information as information that is different from data at the time of normal operation. The second terminal apparatus 2b can transmit a preconfigured value, for example, a value that falls outside the range of normal data transmission, as the malfunction information when the second terminal apparatus 2b transmits data at the time of normal operation. In other words, in a case where the base station apparatus 1 receives data that falls outside the range of normal data from the second terminal apparatus 2b, the base station apparatus 1 can determine that the second terminal apparatus 2b has a malfunction. A plurality of types of malfunction information may be provided. For example, the malfunction information includes a malfunction of a sensor, a communication failure, and a battery shortage. For example, the communication failure is a noticeable deterioration in the communication quality of the base station apparatus 1 from the position of the second terminal apparatus 2b due to a change in the surrounding communication environment such as when the position of the second terminal apparatus 2b is changed due to any cause, or when a building in the surrounding area is changed.

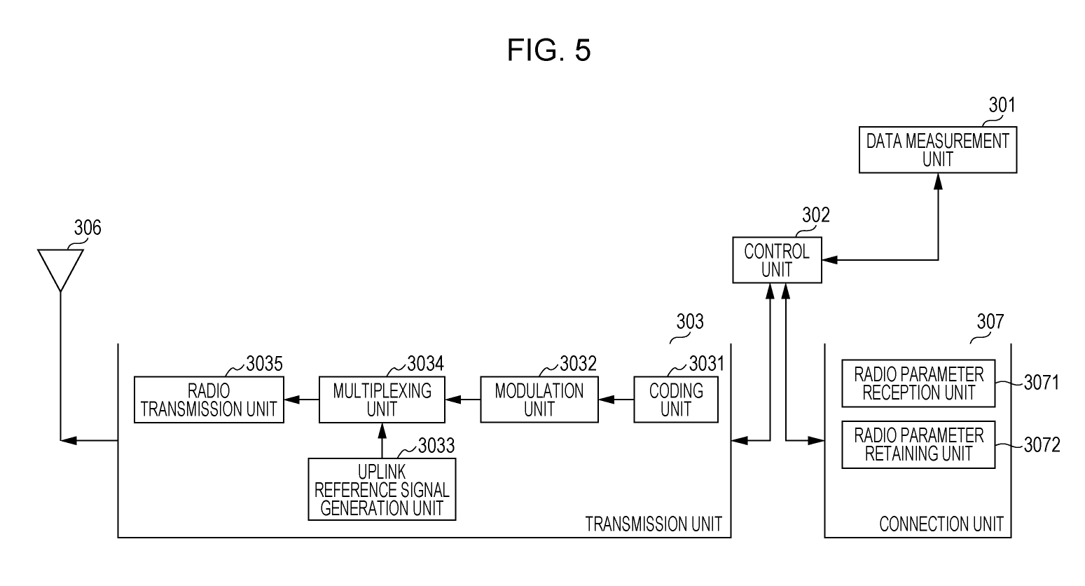

FIG. 5 is a schematic block diagram illustrating a configuration of the second terminal apparatus 2b in the present embodiment. As illustrated in FIG. 5, the terminal apparatus is configured to include a data measurement unit 301, a control unit 302, a transmission unit 303, a transmit antenna 306, and a connection unit 307. The transmission unit 303 is configured to include a coding unit 3031, a modulation unit 3032, an uplink reference signal generation unit 3033, a multiplexing unit 3034, and a radio transmission unit 3035. The connection unit 307 is configured to include a radio parameter reception unit 3071 and a radio parameter retaining unit 3072. The connection unit 307 can be connected to the first terminal apparatus 2a. This connection can be realized as direct connection, wired connection, or wireless connection.

The data measurement unit 301 measures data. For example, the data measurement unit 301 can calculate measured values of temperature, humidity, illumination, water level, and the like or motion data.

The control unit 302 generates the uplink control information based on information such as the measured data input from the data measurement unit 301, and outputs the uplink control information to the transmission unit 303. The control unit 302 can generate the uplink control information based on the radio parameter input from the connection unit 307. The control unit 302 outputs the information such as the measured data input from the data measurement unit 301 to the transmission unit 303 as the uplink data.

In accordance with control information input from the control unit 302, the transmission unit 303 generates the uplink reference signal and codes and modulates the uplink data input from the control unit 302. The transmission unit 303 multiplexes PUCCH, PUSCH, and the generated uplink reference signal, and transmits the multiplexed signal to the base station apparatus through the transmit antenna 306. PUCCH may be changed to another new channel for the uplink control signal that is established for a low-power terminal apparatus. PUSCH may be changed to another new channel for the uplink data signal that is established for a low-power terminal apparatus.

The coding unit 3031 codes the uplink control information input from the control unit 302 using convolutional coding, block coding, and the like. The coding unit 3031 performs coding such as turbo coding based on the information that is used in scheduling of PUSCH.

The modulation unit 3032 modulates a coding bit input from the coding unit 3031 using a modulation scheme such as BPSK, QPSK, 16 QAM, and 64 QAM. The modulation scheme can use information that is included in the radio parameter input from the connection unit 307. The modulation scheme predetermined for each channel can be used.

The uplink reference signal generation unit 3033 generates a sequence that is acquired using a predetermined rule (formula), based on the physical cell identity for identifying the base station apparatus 1, the bandwidth in which the uplink reference signal is to be arranged, the cyclic shift notified in the uplink grant, the value of the parameter for generating the DMRS sequence, and the like. Information included in the radio parameter input from the connection unit 307 can be used as those parameters.

The multiplexing unit 3034 multiplexes the reference signal and the uplink data in accordance with the control information input from the control unit 302. For example, the reference signal and the uplink data can be time-multiplexed using only one subcarrier. In this case, transmission may be performed in cooperation with another second terminal apparatus 2b such that the received signal in the base station apparatus 1 is formed as an OFDM signal. Alternatively, a plurality of subcarriers may be used to perform DFT corresponding to the number of subcarriers on the reference signal or the uplink data, and the result may be mapped to the plurality of subcarriers. Information included in the radio parameter input from the connection unit 307 can be used as subcarrier assignment information.

The radio transmission unit 3035 converts a baseband digital signal into an analog signal in a desired band using filtering, DA conversion, frequency conversion, power amplification, and the like. In a case where only one subcarrier is used, the baseband digital signal can be generated by multiplying corresponding rotation factors. In a case where a plurality of subcarriers is used, the baseband digital signal can be generated by performing IFFT on the mapped signals. The radio transmission unit 3035 outputs the generated analog signal to the transmit antenna 306 to transmit the analog signal.

The connection unit 307 can be connected to the first terminal apparatus 2a. This connection can be realized as wireless connection or wired connection. For example, in a case where the second terminal apparatus 2b is connected to the base station apparatus 1 for the first time, the second terminal apparatus 2b can transmit a connectivity request to the base station apparatus 1 through the connected first terminal apparatus 2a. The first terminal apparatus 2a can receive the radio parameter that is determined by the base station apparatus 1 based on the connectivity request, and the second terminal apparatus 2b can receive the radio parameter from the first terminal apparatus 2a through the connection.

The radio parameter reception unit 3071 receives the radio parameter from the connected first terminal apparatus 2a.

The radio parameter retaining unit 3072 retains the radio parameter received from the connected first terminal apparatus 2a.

Accordingly, by disposing the reception function in the first terminal apparatus 2a, the second terminal apparatus 2b does not have to include a complex reception circuit and can simply perform transmission, thereby realizing low power consumption. A communication system having low power consumption can be built using the first terminal apparatus 2a.

The second terminal apparatus 2b can include a function of receiving a multicast/broadcast signal. For example, the second terminal apparatus 2b can update the position information or correct time using a signal from the base station apparatus. The updated position information is appropriately transmitted to the base station apparatus.

In a case where the function or version of each second terminal apparatus 2b is different, the first terminal apparatus 2a can recognize the function or version of each second terminal apparatus 2b and transmit the function or version to the base station apparatus. The first terminal apparatus 2a can request the base station apparatus to configure the radio parameter corresponding to the function or version of each second terminal apparatus 2b.

A case where the radio parameter used by the second terminal apparatus 2b for transmitting data to the base station apparatus 1 is determined by the first terminal apparatus 2a using communication with the base station apparatus 1 and is transferred (transmitted) to the second terminal apparatus 2b is described above. The second terminal apparatus 2b may transmit data to the first terminal apparatus 2a, and the first terminal apparatus 2a may transmit collected data to the base station apparatus 1. In a case where the first terminal apparatus 2a and the second terminal apparatus 2b are wirelessly connected to each other, the radio parameter transferred (transmitted) to the second terminal apparatus 2b by the first terminal apparatus 2a can be used as the radio parameter used by the second terminal apparatus 2b for transmitting data to the first terminal apparatus 2a. In this case, the first terminal apparatus 2a can configure the malfunction information of the second terminal apparatus 2b. For example, in a case where the first terminal apparatus 2a may not receive a signal at a predetermined timing in the subcarrier assigned to the second terminal apparatus 2b, the first terminal apparatus 2a can configure the malfunction information of the second terminal apparatus 2b.

A program that operates in the base station apparatus and the terminal apparatus according to one aspect of the present invention is a program that controls a CPU and the like (a program that causes a computer to function) to realize the function in the embodiment according to one aspect of the present invention. Information that is handled in those apparatuses is temporarily accumulated in a RAM at the time of processing thereof and then, is stored in various ROMs or HDDs. The information is read and corrected or written by the CPU if desired. A recording medium that stores the program may be any of a semiconductor medium (for example, ROM or non-volatile memory card), an optical recording medium (for example, DVD, MO, MD, CD, or BD), a magnetic recording medium (for example, magnetic tape or flexible disk), or the like. The function of the embodiment is not only realized by executing the loaded program. The function according to one aspect of the present invention may also be realized by processing based on instructions of the program along with an operating system, another application program, and the like.

In a case where the program is distributed in the market, the program can be distributed by being stored in a portable recording medium, or transferred to a server computer that is connected through a network such as the Internet. In this case, a storage device of the server computer also falls in one aspect of the present invention. A part or the entirety of each of the terminal apparatus and the base station apparatus in the embodiment may be typically realized as LSI that is an integrated circuit. Each function block of the reception apparatus may be individually formed as a chip. A part or all of the function blocks may be integrated as a chip. In a case where each function block is formed as an integrated circuit, an integrated circuit control unit that controls the integrated circuits is added.

A method for forming the integrated circuits is not limited to LSI and may be realized using a dedicated circuit or a general-purpose processor. In a case where a technology for forming integrated circuits replacing LSI emerges along with advances in semiconductor technology, integrated circuits formed using the technology can be used.

The present invention is not limited to the embodiment. Application of the terminal apparatus of the present invention is not limited to a mobile station apparatus. The terminal apparatus of the present invention may be applied to a stationary or non-movable electronic apparatus disposed indoors or outdoors, for example, an AV apparatus, a kitchen apparatus, a cleaning or washing apparatus, an air conditioner, an office apparatus, a vending machine, and other household apparatuses.

While the embodiment of the invention is described thus far in detail with reference to the drawings, a specific configuration of the invention is not limited to the embodiment. Designs and the like that are made to an extent not departing from the gist of the invention also fall in the scope of the claims.

### INDUSTRIAL APPLICABILITY

The present invention is suitably used for a terminal apparatus, a base station apparatus, and a communication method.

The present international application claims the benefit of priority based on Japanese Patent Application No. 2015-197490 filed on Oct. 5, 2015. The entire content of Japanese Patent Application No. 2015-197490 is incorporated in the present international application.

### REFERENCE SIGNS LIST

1 BASE STATION APPARATUS
2 TERMINAL APPARATUS
1-1 COVERAGE
2a FIRST TERMINAL APPARATUS
2b-1, 2b-2, 2b-3 SECOND TERMINAL APPARATUS
101 HIGHER LAYER PROCESSING UNIT
102 CONTROL UNIT
103 TRANSMISSION UNIT
104 RECEPTION UNIT
105 TRANSMIT AND RECEIVE ANTENNA
106 TERMINAL APPARATUS INFORMATION PROCESSING UNIT
1011 RADIO RESOURCE CONTROL UNIT
1012 SCHEDULING UNIT
1031 CODING UNIT
1032 MODULATION UNIT
1033 DOWNLINK REFERENCE SIGNAL GENERATION UNIT
1034 MULTIPLEXING UNIT
1035 RADIO TRANSMISSION UNIT
1041 RADIO RECEPTION UNIT
1042 DEMULTIPLEXING UNIT
1043 DEMODULATION UNIT
1044 DECODING UNIT
1061 RADIO PARAMETER CONTROL UNIT
1062 RADIO PARAMETER REGISTRATION UNIT
201 HIGHER LAYER PROCESSING UNIT
202 CONTROL UNIT
203 TRANSMISSION UNIT
204 RECEPTION UNIT
205 CHANNEL STATE INFORMATION GENERATION UNIT
206 TRANSMIT AND RECEIVE ANTENNA
207 CONNECTION UNIT
208 DISPLAY UNIT
2011 RADIO RESOURCE CONTROL UNIT
2012 SCHEDULING INFORMATION ANALYSIS UNIT
2031 CODING UNIT
2032 MODULATION UNIT
2033 UPLINK REFERENCE SIGNAL GENERATION UNIT
2034 MULTIPLEXING UNIT
2035 RADIO TRANSMISSION UNIT
2041 RADIO RECEPTION UNIT
2042 DEMULTIPLEXING UNIT
2043 SIGNAL DETECTION UNIT
2071 RADIO PARAMETER CONTROL UNIT
2072 RADIO PARAMETER TRANSFER UNIT
301 DATA MEASUREMENT UNIT
302 CONTROL UNIT
303 TRANSMISSION UNIT
306 TRANSMIT ANTENNA
307 CONNECTION UNIT
3031 CODING UNIT
3032 MODULATION UNIT
3033 UPLINK REFERENCE SIGNAL GENERATION UNIT
3034 MULTIPLEXING UNIT
3035 RADIO TRANSMISSION UNIT
3071 RADIO PARAMETER RECEPTION UNIT
3072 RADIO PARAMETER RETAINING UNIT

1. A terminal apparatus comprising:
a reception unit that receives a radio parameter and malfunction information from a base station apparatus;
a connection unit that makes connection to an end terminal apparatus including a data transmission function and transmits a parameter including the radio parameter to the end terminal apparatus; and
a display unit that displays position information of an end terminal apparatus having a malfunction in a case where the malfunction information is received.

2. A terminal apparatus comprising:
a connection unit that makes connection to a control terminal apparatus including a function of performing radio communication with a base station apparatus and receives a radio parameter from the control terminal apparatus; and
a transmission unit that transmits a data signal to the base station apparatus using the radio parameter,
wherein the transmission unit transmits malfunction information to the base station apparatus in a case where the terminal apparatus determines that the terminal apparatus has a malfunction.

3. The terminal apparatus according to claim 2,
wherein the malfunction information is information related to a sensor or a battery.

4. A base station apparatus that communicates with a control terminal apparatus and an end terminal apparatus, the base station apparatus comprising:
a transmission unit that transmits a radio parameter to the control terminal apparatus; and
a reception unit that receives a data signal transmitted using the radio parameter from the end terminal apparatus,
wherein the base station apparatus transmits malfunction information to the control terminal apparatus in a case where the base station apparatus determines that the end terminal apparatus has a malfunction.

5. The base station apparatus according to claim 4,
wherein the radio parameter includes a period of data transmission, and
wherein the base station apparatus determines that the end terminal apparatus has the malfunction in a case where the base station apparatus does not receive the data signal from the end terminal apparatus in the period.

6. The base station apparatus according to claim 4,
wherein the base station apparatus determines the malfunction from the data signal received from the end terminal apparatus.

7. The base station apparatus according to claim 4,
wherein the base station apparatus receives a signal indicating the malfunction from the end terminal apparatus and determines the malfunction from the signal indicating the malfunction.

8. The base station apparatus according to claim 4,
wherein the malfunction information includes at least one of information related to communication, information of a sensor, or information of a battery.

9. A communication method that is implemented in a terminal apparatus, comprising:
a reception step of receiving a radio parameter and malfunction information from a base station apparatus;
a connection step of making connection to an end terminal apparatus including a data transmission function, and transmitting a parameter including the radio parameter to the end terminal apparatus; and
a display step of displaying position information of an end terminal apparatus having a malfunction in a case where the malfunction information is received.

10. A communication method that is implemented in a terminal apparatus, comprising:
a connection step of making connection to a control terminal apparatus including a function of performing radio communication with a base station apparatus, and receiving a radio parameter from the control terminal apparatus; and
a transmission step of transmitting a data signal to the base station apparatus using the radio parameter,
wherein, in the transmission step, malfunction information is transmitted to the base station apparatus in a case where a determination is made that the terminal apparatus has a malfunction.

11. A communication method that is implemented in a base station apparatus communicating with a control terminal apparatus and an end terminal apparatus, the method comprising:
a transmission step of transmitting a radio parameter to the control terminal apparatus; and
a reception step of receiving a data signal transmitted using the radio parameter from the end terminal apparatus,
wherein malfunction information is transmitted to the control terminal apparatus in a case where a determination is made that the end terminal apparatus has a malfunction.
